(19) United States
(12) Patent Application Publication
(10) Pub. No.: US 2025/0084993 A1
(43) Pub. Date: Mar. 13, 2025

(54) GAS TURBINE COMBUSTOR AND GAS TURBINE

(71) Applicants: MITSUBISHI HEAVY INDUSTRIES, LTD., Tokyo (JP); MITSUBISHI POWER, LTD., Tokyo (JP)

(72) Inventors: Naoto FUJIWARA, Tokyo (JP); Eiichi KOBAYASHI, Tokyo (JP); Mitsuhiro KARISHUKU, Tokyo (JP); Yasuhiro HORIUCHI, Tokyo (JP)

(21) Appl. No.: 18/729,361

(22) PCT Filed: Jan. 20, 2023
(86) PCT No.: PCT/JP2023/001622

§ 371 Date: Jul. 16, 2024

(30) Foreign Application Priority Data
Jan. 28, 2022 (JP) 2022-011689

(51) Int. Cl. F23M 20/00; F23R 3/00; F23R 3/06

(52) U.S. Cl. CPC F23M 20/005; F23R 3/002; F23R 3/06

(57) ABSTRACT

A gas turbine combustor provided with: a combustion cylinder having a combustion chamber and a plurality of through-holes that open to the combustion chamber; a housing disposed peripherally outwards of the combustion cylinder and defining an acoustic attenuation space that communicates with the combustion chamber via the through-holes; an air hole plate having a plurality of air holes and being positioned upstream of the combustion cylinder; a plurality of fuel nozzles respectively corresponding to the air holes; an air passage provided between the inner peripheral surface of the combustion cylinder and the outer peripheral surface of the air hole plate and extending in the axial direction of the combustion cylinder; and an air supply flow path for supplying air flowing outside the combustion cylinder to the acoustic attenuation space. At least one of the through holes is provided directly below the air hole plate in the axial direction.

### TECHNICAL FIELD

The present disclosure relates to a gas turbine combustor and a gas turbine.

The present application claims priority based on Japanese Patent Application No. 2022-011689 filed in Japan on Jan. 28, 2022, the contents of which are incorporated herein by reference.

### BACKGROUND ART

A gas turbine combustor is known in which an air hole plate is disposed between a fuel nozzle and a combustion chamber, and a fuel flow and an air flow formed on an outer peripheral side of the fuel flow are jetted into the combustion chamber inside an air hole provided in the air hole plate (for example, refer to PTL 1).

### CITATION LIST

### Patent Literature

[PTL 1] JP2018-150912 A

### SUMMARY OF INVENTION

### Technical Problem

The gas turbine combustor as described in PTL 1 is also referred to as a multi-cluster combustor. In the multi-cluster combustor as described in PTL 1, the length of the flame is shorter than that of a combustor in the related art which is not a multi-cluster combustor. Therefore, an antinode and a node of combustion vibration are formed in a vicinity of a burner outlet. Therefore, in order to prevent combustion vibration, it is important to dispose an acoustic device having an acoustic attenuation space directly below the burner.

However, in the gas turbine combustor as described in PTL 1, since a region where the acoustic device is disposed is a region prone to reach a relatively high temperature, it is necessary to achieve both cooling and acoustic characteristics.

An object of at least one embodiment of the present disclosure is, in view of the above-described circumstances, to achieve both cooling and acoustic characteristics in a gas turbine combustor.

### Solution to Problem

(1) A gas turbine combustor according to at least one embodiment of the present disclosure includes:
a combustion cylinder which includes a combustion chamber inside and in which a plurality of through-holes open to the combustion chamber are formed;
a housing that is disposed on an outer peripheral side of the combustion cylinder and that defines an acoustic attenuation space that communicates with the combustion chamber via the through-hole;
an air hole plate in which a plurality of air holes are formed and which is positioned on an upstream side of the combustion cylinder;
a plurality of fuel nozzles that correspond to the plurality of air holes, respectively;
an air passage that is provided between an inner peripheral surface of the combustion cylinder and an outer peripheral surface of the air hole plate and that extends in an axial direction of the combustion cylinder; and
an air supply flow path for supplying air flowing on an outer side of the combustion cylinder to the acoustic attenuation space,
in which at least one of the plurality of through-holes is provided directly below the air hole plate in the axial direction.

(2) A gas turbine according to at least one embodiment of the present disclosure includes:
a compressor that generates compressed air;
the gas turbine combustor according to the above (1); and a turbine that is rotationally driven by combustion gas generated by the gas turbine combustor.

### Advantageous Effects of Invention

According to at least one embodiment of the present disclosure, it is possible to achieve both cooling and acoustic characteristics in a gas turbine combustor.

### BRIEF DESCRIPTION OF DRAWINGS

FIG. 1 is a diagram showing a schematic configuration of a gas turbine that is provided with a gas turbine combustor according to an embodiment of the present disclosure.

FIG. 2A is a schematic partial cross-sectional view in which a vicinity of an end portion on an axial upstream side of a combustor liner in the gas turbine combustor according to the embodiment provided in the gas turbine shown in FIG. 1 is enlarged.

FIG. 2B is an enlarged view of a portion A of FIG. 2A.

FIG. 3 is a cross-sectional view taken along line III-III of FIG. 2A.

FIG. 4 is a cross-sectional view taken along line IV-IV of FIG. 2A.

FIG. 5 is a cross-sectional view taken along line V-V of FIG. 2A.

FIG. 6A is a cross-sectional view taken along line VI-VI of FIG. 2A.

FIG. 6B is a view corresponding to a cross-sectional view taken along line VI-VI of FIG. 2A.

### DESCRIPTION OF EMBODIMENTS

Hereinafter, some embodiments of the present disclosure will be described with reference to the accompanying drawings. However, dimensions, materials, shapes, and relative dispositions of components described as the embodiments or illustrated in the drawings are not intended to limit the scope of the present disclosure, and are merely examples for describing the present disclosure.

For example, expressions representing relative or absolute dispositions such as “in a certain direction”, “along a certain direction”, “parallel”, “orthogonal”, “center”, “concentric”, or “coaxial” not only strictly represent the dispositions, but also represent a state where the dispositions are relatively displaced with a tolerance or at an angle or a distance to such an extent that the same function can be obtained.

For example, expressions representing that things are in an equal state such as “same”, “equal”, and “homogeneous” not only strictly represent an equal state, but also represent a state where a difference exists with a tolerance or to such an extent that the same function can be obtained.

For example, expressions representing shapes such as a quadrangular shape and a cylindrical shape not only represent shapes such as a quadrangular shape and a cylindrical shape in a geometrically strict sense, but also represent shapes including an uneven portion or a chamfered portion within a range where the same effect can be obtained.

In addition, expressions of “being provided with”, “being equipped with”, “including”, or “having” one component are not exclusive expressions excluding the presence of other components.

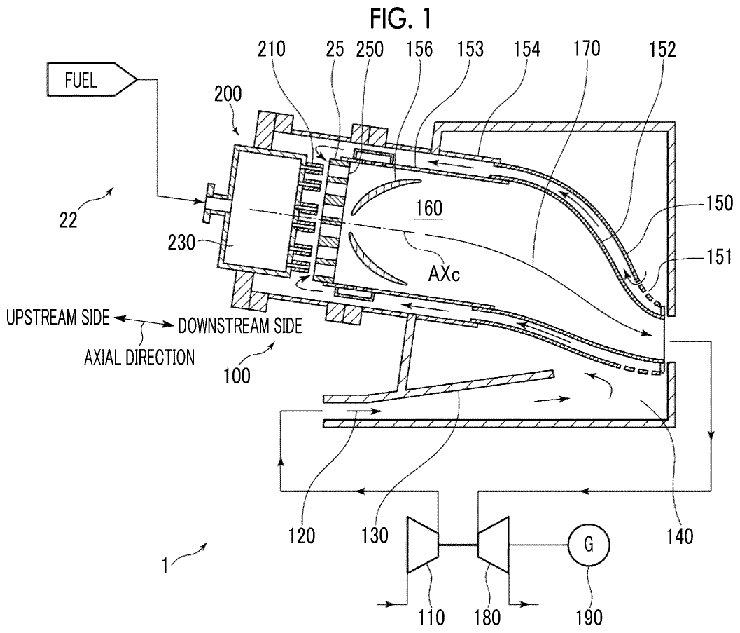

A gas turbine combustor according to an embodiment of the present disclosure will be described with reference to FIG. 1.

FIG. 1 shows a schematic configuration of a gas turbine including a gas turbine combustor according to an embodiment of the present disclosure.

A gas turbine 1 shown in FIG. 1 includes an air compressor 110, a gas turbine combustor 100, and a turbine 180.

The gas turbine combustor 100 according to one embodiment includes a combustor liner (inner cylinder) 153, a liner flow sleeve (outer cylinder) 154, a transition piece 152, a transition piece flow sleeve 150, a burner 200, and a fuel system 22. In addition, in FIG. 1, the burner 200 and the fuel system 22 are simplified.

In the gas turbine 1 shown in FIG. 1, the air compressor 110 is rotationally driven by the turbine 180, compresses air (suction air) sucked from the atmosphere via an intake port (not illustrated) to generate high-pressure air (combustion air) 120, and supplies the high-pressure air 120 to the gas turbine combustor 100. The gas turbine combustor 100 mixes the high-pressure air 120 supplied from the air compressor 110 with fuel supplied from the fuel system 22 to combust the mixture, generates a high-temperature combustion gas 170, and supplies the combustion gas 170 to the turbine 180.

That is, in the gas turbine 1 shown in FIG. 1, the high-pressure air 120 which is combustion air discharged from the air compressor 110 is introduced into a casing 140 from a diffuser 130, and flows into a flow path formed in a gap between the transition piece flow sleeve 150 and the transition piece 152 disposed inside the transition piece flow sleeve 150 from an air introduction hole 151 provided in the transition piece flow sleeve 150 of the gas turbine combustor 100.

The high-pressure air 120 that has flowed into the flow path formed in the gap then flows through the flow path formed in a gap between the combustor liner 153 of the gas turbine combustor 100 and the liner flow sleeve 154 concentrically disposed with the combustor liner 153 on an outer peripheral side of the combustor liner 153, and then the flow is reversed. The high-pressure air 120 is mixed with the fuel injected from the fuel system 22 and a plurality of fuel nozzles 210 constituting a cluster nozzle, and is combusted in a combustion chamber 160 inside the combustor liner 153 to form a flame 156, thereby generating the high-temperature and high-pressure combustion gas 170.

In this way, the high-temperature and high-pressure combustion gas 170 generated in the gas turbine combustor 100 flows down in the transition piece 152, and is introduced into the turbine 180.

In the turbine 180 forming the gas turbine 1, a work amount generated when the high-temperature and high-pressure combustion gas 170 introduced into the turbine 180 is subjected to adiabatic expansion is converted into a shaft rotational force by the turbine 180. In this manner, an output is obtained from a generator 190 by driving the generator 190 connected to the turbine 180 by a turbine shaft.

The air compressor 110 and the generator 190 which form the gas turbine 1 are connected to the turbine 180 by the turbine shaft. However, the air compressor 110, the turbine 180, and the generator 190 may not have a configuration in which the turbine shaft has a single shaft, and may have a configuration in which the turbine shaft has two or more shafts.

In addition, the gas turbine which is generally widely used in a thermal power plant has a configuration in which a plurality of the gas turbine combustors are radially arranged with respect to the turbine shaft.

In the following description, a direction along a central axis Axc of the gas turbine combustor 100 is referred to as an axial direction of the gas turbine combustor 100 or simply as an axial direction. A direction in which the combustion gas 170 flows along the axial direction is referred to as an axial downstream side or simply as a downstream side. A direction opposite to a direction of a flow of the combustion gas 170 is referred to as an axial upstream side or simply as an upstream side.

In the gas turbine combustor 100 according to the embodiment, the central axis Axc of the gas turbine combustor 100 is, for example, a central axis of the combustor liner 153 having a cylindrical shape. That is, the axial direction of the gas turbine combustor 100 is the axial direction of the combustor liner 153.

In addition, in the following description, a circumferential direction of the combustor liner 153 is also simply referred to as a circumferential direction, and a radial direction of the combustor liner 153 is also simply referred to as a radial direction.

### (Outline of Gas Turbine Combustor 100)

A gas turbine combustor 100 according to an embodiment is a hydrogen-exclusive combustor.

Accordingly, it is possible to prevent the gas turbine combustor 100 from discharging carbon dioxide.

The gas turbine combustor 100 according to the embodiment may be a gas turbine combustor capable of combusting hydrogen fuel and other fuel other than hydrogen fuel, and may combust, for example, natural gas fuel as the other fuel. The gas turbine combustor 100 according to the embodiment may be a gas turbine combustor capable of performing hydrogen fuel diffusion combustion, natural gas fuel diffusion combustion, and mixed combustion of hydrogen fuel and natural gas fuel.

As shown in FIG. 1, in the gas turbine combustor 100 according to the embodiment, the burner 200 is disposed to be orthogonal to the central axis Axc of the gas turbine combustor 100 and is provided at an end portion on the axial upstream side of the combustor liner 153. In the gas turbine combustor 100 according to the embodiment, the burner 200 includes a fuel header 230, the plurality of fuel nozzles 210, and an air hole plate 25.

The gas turbine combustor 100 according to the embodiment is a combustor of a type called a so-called multi-cluster combustor. In the gas turbine combustor 100 according to the embodiment, a plurality of air holes 250 are formed in the air hole plate 25. The plurality of fuel nozzles 210 are respectively disposed to correspond to each of the plurality of air holes 250 formed in the air hole plate 25 disposed close to the axial downstream side of the fuel nozzles 210, and are respectively disposed to be coaxial with each of the plurality of air holes 250.

The hydrogen fuel injected toward the plurality of air holes 250 formed in the air hole plate 25 from the plurality of fuel nozzles 210 is jetted into the combustion chamber 160 together with the combustion air supplied from the air compressor 110, and is rapidly mixed and combusted to form the flame 156 as described above, thereby generating the high-temperature and high-pressure combustion gas 170.

### (Details of Gas Turbine Combustor 100)

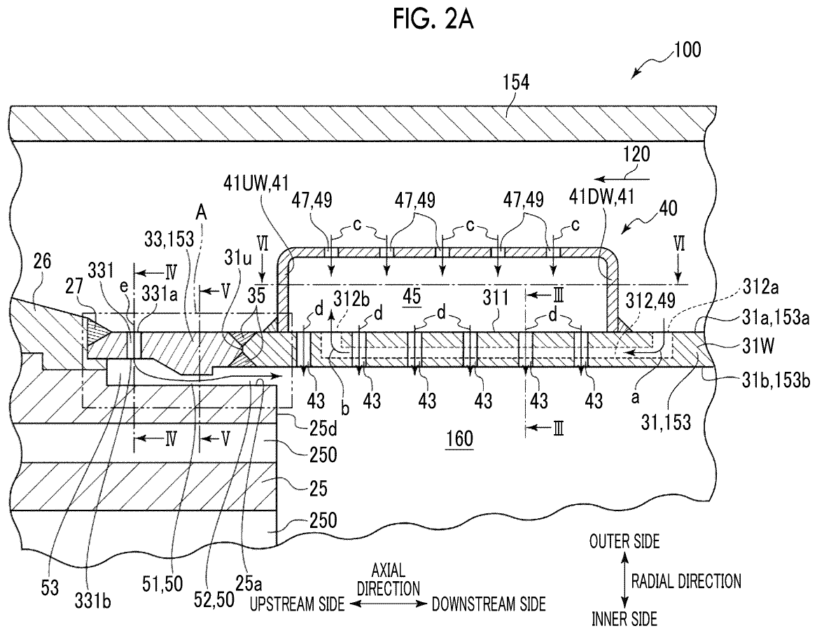

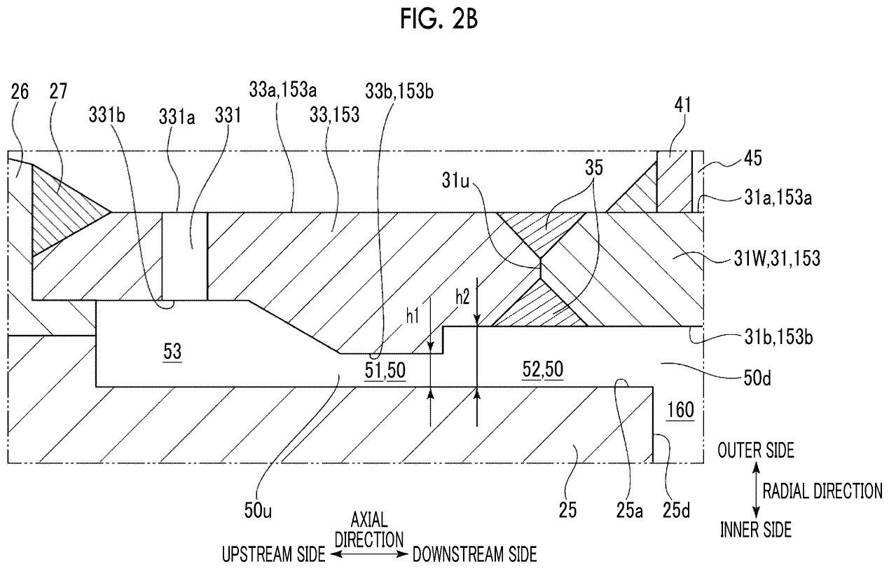

FIG. 2A is a schematic partial cross-sectional view in which a vicinity of an end portion on the axial upstream side of the combustor liner 153 in the gas turbine combustor 100 according to the embodiment provided in the gas turbine 1 shown in FIG. 1 is enlarged.

FIG. 2B is an enlarged view of a portion A of FIG. 2A.

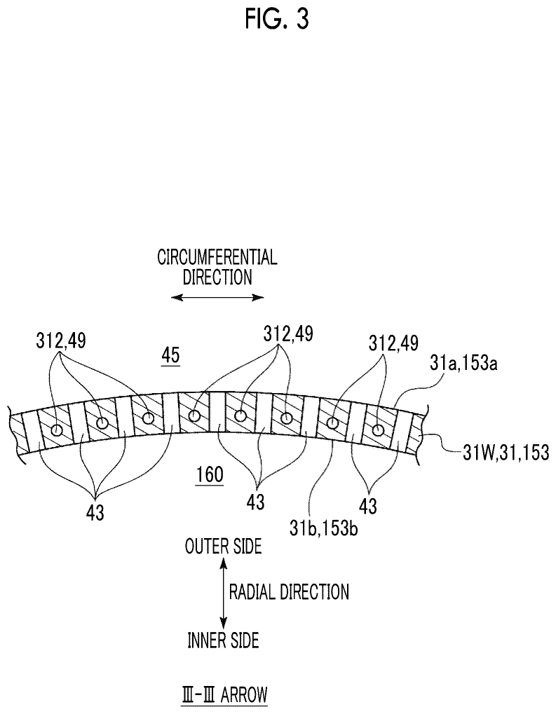

FIG. 3 is a cross-sectional view taken along line III-III of FIG. 2A.

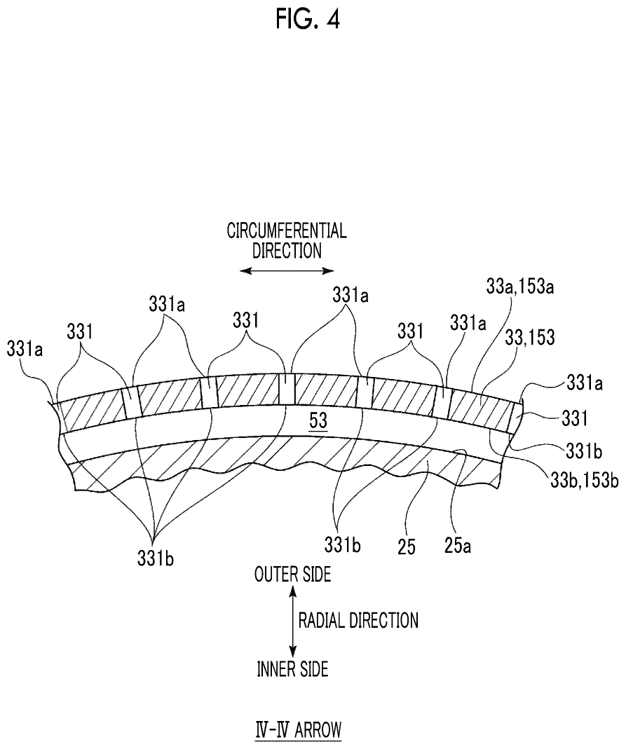

FIG. 4 is a cross-sectional view taken along line IV-IV of FIG. 2A.

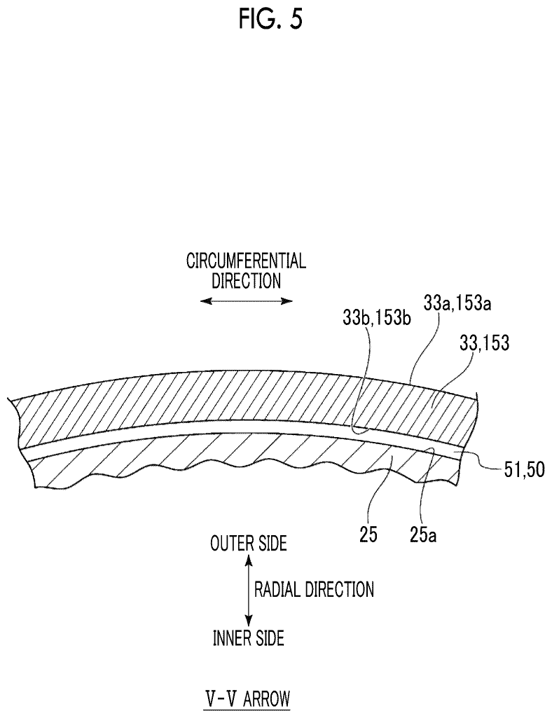

FIG. 5 is a cross-sectional view taken along line V-V of FIG. 2A.

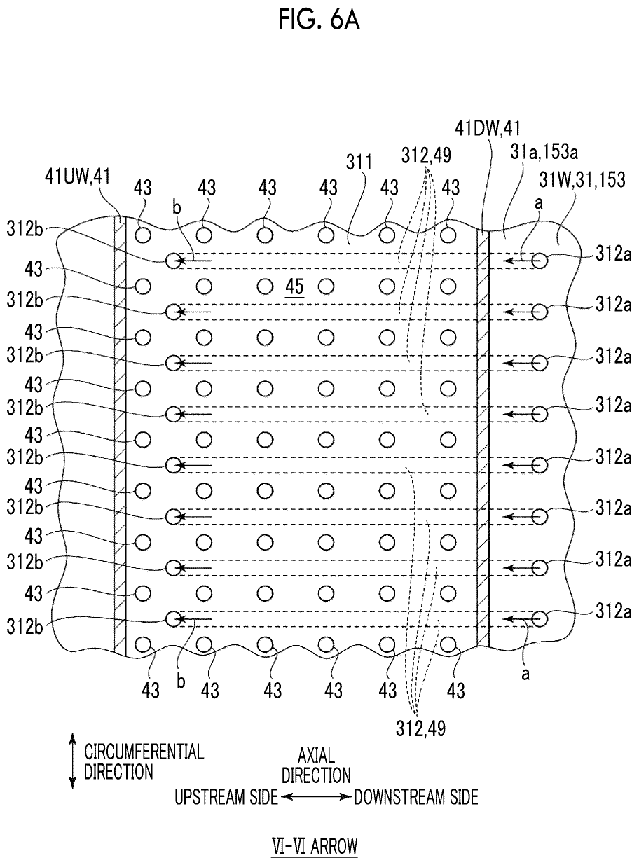

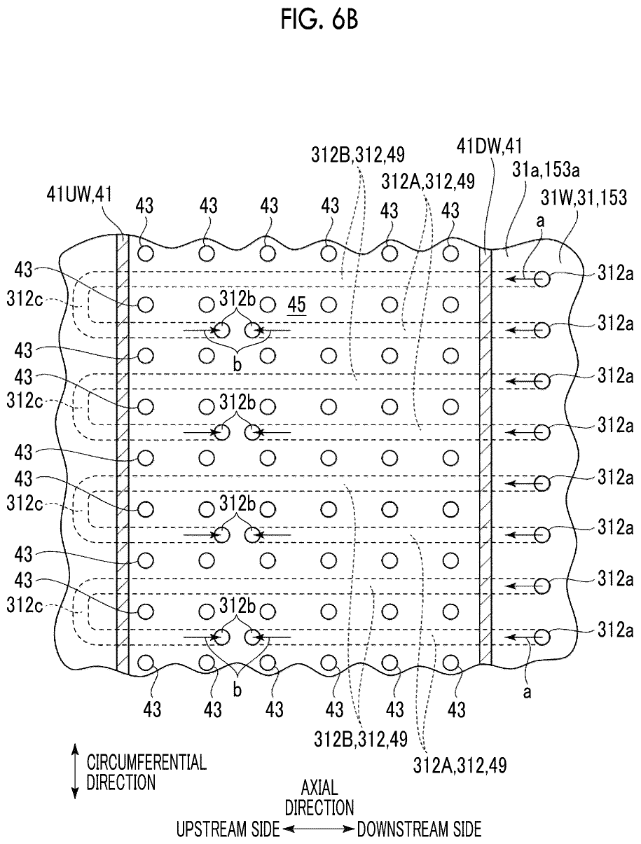

FIG. 6A is a cross-sectional view taken along line VI-VI of FIG. 2A.

FIG. 6B is a view corresponding to the cross-sectional view taken along line VI-VI of FIG. 2A and shows another example of a cooling passage 312 to be described later.

Hereinafter, details of a gas turbine combustor 100 according to an embodiment will be described with reference to FIGS. 2A to 6B.

In the gas turbine combustor 100 according to the embodiment, the burner 200 includes an air hole plate outer peripheral support 26 that supports an outer peripheral portion of the air hole plate 25.

In the gas turbine combustor 100 according to the embodiment, the combustor liner 153 includes a combustion cylinder body 31 forming the combustion chamber 160, and a combustion cylinder fixing adapter 33 connected to an end portion 31u on the axial upstream side of the combustion cylinder body 31 by a welded portion 35.

In the gas turbine combustor 100 according to the embodiment, a portion on the axial downstream side of the air hole plate outer peripheral support 26 and an end portion on the axial upstream side of the combustion cylinder fixing adapter 33 are connected to each other by a welded portion 27.

The gas turbine combustor 100 according to the embodiment includes an acoustic device 40 attached to the combustion cylinder body 31 of the combustor liner 153.

The acoustic device 40 includes a housing 41 and an acoustic hole 43. The combustion cylinder body 31 of the combustor liner 153 has a region 311 covered with the housing 41, and at least one acoustic hole 43 is formed in the region 311. For example, a plurality of acoustic holes 43 are formed in the region 311, and each acoustic hole 43 has a circular cross-sectional shape. The acoustic hole 43 is a through-hole that is open to the combustion chamber 160.

The housing 41 is disposed on an outer peripheral side of the combustion cylinder body 31 to define an acoustic attenuation space 45 that communicates with the combustion chamber 160 via the acoustic hole 43. The housing 41 extends along the circumferential direction of the combustion cylinder body 31.

The housing 41 is fixed to the combustor liner 153 by welding, for example.

In the gas turbine combustor 100 according to the embodiment, pressure fluctuation in the combustion chamber 160 due to combustion vibration is attenuated by the acoustic device 40 attached to the combustor liner 153.

The acoustic device 40 according to the embodiment is an acoustic device called an acoustic liner, and can absorb a relatively high-frequency sound caused by combustion vibration. However, the acoustic device 40 may be an acoustic damper that can absorb a relatively low-frequency sound caused by combustion vibration. In addition, an acoustic damper (not illustrated) may be provided together with the acoustic device 40 according to the embodiment.

In addition, in the gas turbine combustor 100 according to the embodiment, a plurality of acoustic devices may be disposed in different regions in the circumferential direction such that the frequencies of the combustion vibrations to be attenuated are different from each other by making the height of the housing 41 in the radial direction different.

In the gas turbine combustor 100 according to the embodiment, at least one of the plurality of acoustic holes 43 may be provided directly below the air hole plate 25 in the axial direction. In the example shown in FIGS. 2A and 2B, all of the plurality of acoustic holes 43 are provided directly below the air hole plate 25 in the axial direction.

The region directly below the air hole plate 25 in the axial direction is, for example, a region on the axial upstream side with respect to a reaction zone of the flame 156. After the combustion of the burner 200, a trace of the flame is observed on an inner peripheral surface 153b of the combustor liner 153 (inner peripheral surface 31b of the combustion cylinder body 31). The region directly below the air hole plate 25 in the axial direction is, for example, a region on the axial upstream side with respect to the trace of the flame.

In a gas turbine combustor, which is referred to as a multi-cluster combustor, such as the gas turbine combustor 100 according to the embodiment, the length of the flame is shorter than that of a combustor in the related art, which is not a multi-cluster combustor. Therefore, a node and an antinode of combustion vibration are formed in a vicinity of a burner outlet. Therefore, in order to prevent combustion vibration, it is important to dispose the acoustic device 40 having the acoustic attenuation space 45 directly below the burner 200 (air hole plate 25).

However, in the gas turbine combustor such as the gas turbine combustor 100 according to the embodiment, since the region 311 where the acoustic device 40 is disposed is a region prone to reach a relatively high temperature, it is necessary to achieve both cooling and acoustic characteristics. In particular, in a case where hydrogen is used as the fuel as in the gas turbine combustor 100 according to one embodiment which is a hydrogen-exclusive combustor, or in a case where a fuel containing a relatively large amount of hydrogen is used, the flame moves back to the axial upstream side as the combustion speed increases. Therefore, since the flame is formed directly below the burner 200 and a most upstream portion of the combustor liner 153 is exposed to the flame, it is difficult to cool the most upstream portion of the combustor liner 153.

Therefore, in the gas turbine combustor 100 according to the embodiment, the cooling air is blown from the acoustic hole 43 to the combustion chamber 160 as will be described later, so that the flame is prevented from entering the acoustic attenuation space 45 through the acoustic hole 43, and the cooling of the most upstream portion of the combustor liner 153 prone to reach a relatively high temperature is performed.

In addition, in the gas turbine combustor 100 according to the embodiment, the cooling air is blown into the combustion chamber 160 from an air passage 50 between the inner peripheral surface 153b of the combustor liner 153 and an outer peripheral surface 25a of the air hole plate 25 as described below, and thus the most upstream portion of the combustor liner 153 prone to reach a relatively high temperature is film-cooled by the cooling air blown from the air passage 50.

In the gas turbine combustor 100 according to the embodiment, at least one of the plurality of acoustic holes 43 is provided directly below the air hole plate 25 in the axial direction. Therefore, combustion vibration can be effectively prevented.

(Cooling by Cooling Air from Acoustic Holes 43)

The gas turbine combustor 100 according to the embodiment includes an air supply flow path 49 for supplying the high-pressure air 120, which is the air flowing on an outer side of the combustor liner 153, to the acoustic attenuation space 45.

Specifically, as shown in FIGS. 2A, 3, 6A, and 6B, a plurality of cooling passages 312 extending along the axial direction are formed at intervals along the circumferential direction in the combustion cylinder body 31 of the combustor liner 153 in a wall 31W forming the combustion cylinder body 31. The plurality of cooling passages 312 have an inlet opening 312a that is open to an outer peripheral surface 31a of the combustion cylinder body 31 on the axial downstream side with respect to the housing 41, and an outlet opening 312b that is open to the outer peripheral surface 31a of the combustion cylinder body 31 to face the acoustic attenuation space 45, and form the air supply flow path 49.

In an example shown in FIG. 6A, a portion on a most upstream side in the axial direction of the plurality of cooling passages 312 is the outlet opening 312b, and the outlet opening 312b is positioned on the axial downstream side with respect to a wall member 41UW on the axial upstream side of the housing 41.

In another example shown in FIG. 6B, in a part of the plurality of cooling passages 312, that is, in a part of cooling passages (first cooling passages) 312A, the portion on the most upstream side in the axial direction is the outlet opening 312b, and the outlet opening 312b is positioned on the axial downstream side with respect to the wall member 41UW on the axial upstream side of the housing 41.

In another example shown in FIG. 6B, in the other part of the plurality of cooling passages 312, that is, in the other part of the plurality of cooling passages (second cooling passages) 312B, the portion on the most upstream side in the axial direction is positioned on the axial upstream side with respect to the wall member 41UW on the axial upstream side of the housing 41. That is, in another example shown in FIG. 6B, the plurality of second cooling passages 312B extend, toward the axial upstream side, from the inlet opening 312a positioned on the axial downstream side with respect to a wall member 41DW on the axial downstream side of the housing 41 to the axial upstream side with respect to the wall member 41UW on the axial upstream side of the housing 41, and reach a region on the axial upstream side with respect to the region 311 in which the acoustic device 40 is disposed. Then, the plurality of second cooling passages 312B are folded back toward the axial downstream side at a folded-back portion 312c positioned in the region on the axial upstream side with respect to the region 311 in which the acoustic device 40 is disposed, and extend to the outlet opening 312b that is open toward the acoustic attenuation space 45 on the outer peripheral surface 31a of the combustion cylinder body 31.

The folded-back portion 312c is positioned on the axial downstream side with respect to the welded portion 35.

Accordingly, in the example shown in FIGS. 2A and 6A, the high-pressure air 120 flowing on the outer side of the combustor liner 153 flows into the plurality of cooling passages 312 from the inlet opening 312a as indicated by an arrow a, and flows toward the axial upstream side. The high-pressure air 120 flowing through the plurality of cooling passages 312 flows into the acoustic attenuation space 45 from the outlet opening 312b as indicated by an arrow b while cooling the combustor liner 153 as cooling air.

In addition, in the example shown in FIG. 6B, the high-pressure air 120 flowing on the outer side of the combustor liner 153 flows into the plurality of cooling passages 312 from the inlet opening 312a as indicated by an arrow a, and flows toward the axial upstream side. The high-pressure air 120 flowing through the plurality of first cooling passages 312A flows into the acoustic attenuation space 45 from the outlet opening 312b as indicated by an arrow b while cooling the combustor liner 153 as cooling air. The high-pressure air 120 flowing through the plurality of second cooling passages 312B cools the combustor liner 153 in the region 311 in which the acoustic device 40 is disposed as cooling air, and flows into the acoustic attenuation space 45 from the outlet opening 312b as indicated by the arrow b while cooling the region on the axial upstream side with respect to the region 311.

As described above, in the example shown in FIG. 6B, compared to the example shown in FIG. 6A, the region on the axial upstream side with respect to the region 311 in which the acoustic device 40 is disposed can be further cooled without increasing the flow rate of the cooling air flowing through the plurality of cooling passages 312.

In the gas turbine combustor 100 according to the embodiment, the housing 41 has at least one housing through-hole 47 that penetrates the housing 41 and that configures the air supply flow path 49. In the example shown in FIG. 2A, the housing 41 has a plurality of housing through-holes 47.

The plurality of housing through-holes 47 are purge holes for guiding the high-pressure air 120 to the acoustic attenuation space 45.

In this manner, the high-pressure air 120 flowing on the outer side of the combustor liner 153 flows into the acoustic attenuation space 45 via the plurality of housing through-holes 47 as indicated by an arrow c in FIG. 2A.

When the cooling air (high-pressure air 120) flowing into the acoustic attenuation space 45 is jetted into the combustion chamber 160 via the plurality of acoustic holes 43 as indicated by an arrow d in FIG. 2A, the cooling air flows through the plurality of acoustic holes 43 to cool an inner peripheral surface of each of the acoustic holes 43. In addition, the cooling air flowing into the combustion chamber 160 from the acoustic hole 43 performs film-cooling for the inner peripheral surface 153b of the combustor liner 153 (inner peripheral surface 31b of the combustion cylinder body 31).

In the gas turbine combustor 100 according to the embodiment, the high-pressure air 120 flowing on the outer side of the combustor liner 153 can be flowed as the cooling air in the plurality of cooling passages 312. Therefore, the combustor liner 153 can be effectively cooled. In addition, in the gas turbine combustor 100 according to the embodiment, the cooling air that has flowed through the plurality of cooling passages 312 can be supplied to the acoustic attenuation space 45. Therefore, the cooling air can be blown into the combustion chamber 160 from the plurality of acoustic holes 43. Accordingly, the cooling air can be efficiently used, and the flame can be prevented from entering the acoustic attenuation space 45 through the plurality of acoustic holes 43.

In the gas turbine combustor 100 according to the embodiment, the high-pressure air 120 flowing on the outer side of the combustor liner 153 can be introduced from the housing through-hole 47 into the acoustic attenuation space 45 and blown into the combustion chamber 160 from the plurality of acoustic holes 43. Accordingly, a region prone to reach a relatively high temperature can be cooled by the cooling air blown out from the plurality of acoustic holes 43, and the flame can be prevented from entering the acoustic attenuation space 45 through the plurality of acoustic holes 43.

In the gas turbine combustor 100 according to the embodiment, the high-pressure air 120 (cooling air) supplied into the acoustic attenuation space 45 via the air supply flow path 49 can be blown into the combustion chamber 160 from at least one acoustic hole 43 provided directly below the air hole plate 25 in the axial direction. Accordingly, the region which is prone to reach a relatively high temperature and which is directly below the air hole plate 25 in the axial direction can be cooled by the cooling air blown out from at least one acoustic hole 43. In addition, in the gas turbine combustor 100 according to the embodiment, the cooling air is blown out from the plurality of acoustic holes 43. In this manner, the flame can be prevented from entering the acoustic attenuation space 45 through the plurality of acoustic holes 43.

(Cooling by Cooling Air from Air Passage 50)

In the gas turbine combustor 100 according to the embodiment, as shown in FIGS. 2A, 2B, 4, and 5, the inner peripheral surface 153b of the combustor liner 153 and the outer peripheral surface 25a of the air hole plate 25 are separated from each other in the radial direction, and an annular space is formed.

An annular cavity 53 and an air passage 50 are defined between the inner peripheral surface 153b of the combustor liner 153 and the outer peripheral surface 25a of the air hole plate 25 in this order from the upstream side.

That is, the gas turbine combustor 100 according to the embodiment includes the annular cavity 53 formed between the inner peripheral surface 153b of the combustor liner 153 (the inner peripheral surface 33b of the combustion cylinder fixing adapter 33) and the outer peripheral surface 25a of the air hole plate 25 and extending in the circumferential direction.

The gas turbine combustor 100 according to the embodiment includes the air passage 50 that is provided between the inner peripheral surface 153b of the combustor liner 153 and the outer peripheral surface 25a of the air hole plate 25 and that extends in the axial direction.

The annular cavity 53 according to the embodiment is formed such that a cross-sectional area when viewed in the axial direction is larger than a cross-sectional area of the air passage 50.

As shown in FIG. 2B, the combustion cylinder fixing adapter 33 of the combustor liner 153 is formed with a plurality of adapter through-holes 331 each having an inlet opening 331a that is open to an outer peripheral surface 33a of the combustion cylinder fixing adapter 33 and an outlet opening 331b that is open to the inner peripheral surface 33b of the combustion cylinder fixing adapter 33. As shown in FIG. 4, the plurality of adapter through-holes 331 are disposed over the entire circumference at intervals in the circumferential direction. Each of the outlet openings 331b faces the annular cavity 53.

The air passage 50 according to one embodiment is an annular air passage extending in the circumferential direction, and includes a first region 51 and a second region 52 positioned on the axial downstream side with respect to the first region 51. A height h2 of the second region 52 in the radial direction is larger than a height h1 of the first region 51 in the radial direction.

In the air passage 50 according to the embodiment, the height in the radial direction changes in a step shape from the first region 51 to the second region 52. Therefore, in the air passage 50 according to the embodiment, a flow path area increases in a step-like manner from the first region 51 to the second region 52.

The air passage 50 is connected to the annular cavity 53 at an upstream end 50u of the air passage 50 in the axial direction.

In the gas turbine combustor 100 according to the embodiment, the high-pressure air 120 flowing on the outer side of the combustor liner 153 flows into the plurality of adapter through-holes 331 from the inlet opening 331a of the adapter through-hole 331 as indicated by an arrow e in FIG. 2A, and flows into the annular cavity 53 from the outlet opening 331b. The high-pressure air 120 flowing into the annular cavity 53 flows into the air passage 50 in the annular cavity 53 while deviation of a flow speed in the circumferential direction is prevented.

When the high-pressure air 120 flowing into the air passage 50 flows from the first region 51 to the second region 52, the flow path area increases in a step-like manner. Therefore, the flow is disturbed, pressure loss occurs, and the deviation of the flow speed in the circumferential direction toward the axial downstream side is prevented.

The high-pressure air 120 flowing into the combustion chamber 160 from the air passage 50 is film-cooled in a region directly below the air hole plate 25 in the axial direction as cooling air.

In the gas turbine combustor 100 according to the embodiment, the cooling air is blown from the air passage 50 between the inner peripheral surface 153b of the combustor liner 153 and the outer peripheral surface 25a of the air hole plate 25 into the combustion chamber 160. In this manner, the region which is prone to reach a relatively high temperature and which is directly below the air hole plate 25 in the axial direction can be film-cooled with the cooling air blown from the air passage 50. In addition, in the gas turbine combustor 100 according to the embodiment, the cooling air is blown into the combustion chamber 160 from the air passage 50. In this manner, the flame can be prevented from entering the acoustic attenuation space through the plurality of acoustic holes 43.

In the gas turbine combustor 100 according to the embodiment, the annular cavity 53 formed between the inner peripheral surface 153b of the combustor liner 153 (the inner peripheral surface 33b of the combustion cylinder fixing adapter 33) and the outer peripheral surface 25a of the air hole plate 25 and extending in the circumferential direction is provided. Therefore, it is possible to prevent the occurrence of a deviation in the circumferential direction in the flow speed of the cooling air, which is blown from the air passage 50 to the combustor liner 153 to perform film-cooling. Accordingly, a temperature difference in the circumferential direction of the combustor liner 153 can be prevented.

In the gas turbine combustor 100 according to the embodiment, as described above, the height of the air passage 50 in the radial direction changes in a step shape from the first region 51 to the second region 52. Therefore, even when there is a deviation in the flow speed of the high-pressure air 120 (cooling air) flowing through the first region 51 in the circumferential direction, the deviation in the circumferential direction can be prevented by disturbing the high-pressure air 120 (cooling air) when the high-pressure air 120 (cooling air) flows from the first region 51 to the second region 52. Accordingly, it is possible to prevent the occurrence of a deviation in the flow speed of the cooling air blown from the air passage 50 to perform film-cooling on the combustor liner 153 in the circumferential direction.

In the gas turbine combustor 100 according to the embodiment, the welded portion 35 connecting the combustion cylinder fixing adapter 33 and the combustion cylinder body 31 is positioned on the upstream side of a downstream end 50d of the air passage 50 in the axial direction. That is, the welded portion 35 is positioned on the upstream side with respect to a downstream end 25d of the air hole plate 25.

Accordingly, the welded portion 35 which is relatively easily affected by heat can be effectively cooled by the cooling air flowing through the air passage 50.

In the gas turbine combustor 100 according to the embodiment, the welded portion 35 is positioned within an extending range of the second region 52 in the axial direction.

Accordingly, the welded portion 35 can be cooled by the high-pressure air 120 (cooling air) in which the deviation of the flow speed in the circumferential direction is prevented in the process of flowing from the first region 51 to the second region 52. Therefore, the deviation of the temperature of the welded portion 35 in the circumferential direction can be prevented.

As described above, in the gas turbine combustor 100 according to the embodiment, it is possible to achieve both the cooling and the acoustic characteristics in the gas turbine combustor 100.

In addition, the gas turbine 1 including the gas turbine combustor 100 according to the embodiment can realize the gas turbine 1 including the gas turbine combustor 100 that achieves both cooling and acoustic characteristics.

The present disclosure is not limited to the above-described embodiments, and also includes a form in which modifications are added to the above-described embodiments or a form in which the embodiments are combined with each other as appropriate.

For example, contents described in each of the above-described embodiments are understood as follows.

(1) A gas turbine combustor 100 according to at least one embodiment of the present disclosure includes: a combustion cylinder (combustor liner 153) which includes a combustion chamber 160 inside and in which a plurality of through-holes (acoustic holes 43) open to the combustion chamber 160 are formed; a housing 41 that is disposed on an outer peripheral side of the combustion cylinder (combustor liner 153) and that defines an acoustic attenuation space 45 that communicates with the combustion chamber 160 via the through-hole (acoustic hole 43); and an air hole plate 25 in which a plurality of air holes 250 are formed and which is positioned on an upstream side of the combustion cylinder (combustor liner 153). The gas turbine combustor 100 according to at least one embodiment of the present disclosure includes: a plurality of fuel nozzles 210 that correspond to the plurality of air holes 250, respectively; an air passage 50 that is provided between an inner peripheral surface 153b of the combustion cylinder (combustor liner 153) and an outer peripheral surface 25a of the air hole plate 25 and that extends in an axial direction of the combustion cylinder (combustor liner 153); and an air supply flow path 49 for supplying air (high-pressure air 120) flowing on an outer side of the combustion cylinder (combustor liner 153) to the acoustic attenuation space 45. At least one of the plurality of through-holes (acoustic holes 43) is provided directly below the air hole plate 25 in the axial direction.

According to the configuration of (1), the air (cooling air) supplied into the acoustic attenuation space 45 via the air supply flow path 49 can be blown into the combustion chamber 160 from at least one through-hole (acoustic hole 43) provided directly below the air hole plate 25 in the axial direction. Accordingly, a region prone to reach a relatively high temperature can be cooled by the cooling air blown from at least one through-hole (acoustic hole 43). In addition, according to the configuration of (1), the cooling air is blown out from the plurality of through-holes (acoustic holes 43). In this manner, the flame can be prevented from entering the acoustic attenuation space 45 through the plurality of through-holes (acoustic holes 43).

According to the configuration of (1), the cooling air is blown into the combustion chamber 160 from the air passage 50 between the inner peripheral surface 153b of the combustion cylinder (combustor liner 153) and the outer peripheral surface 25a of the air hole plate 25. In this manner, the region prone to reach a relatively high temperature can be film-cooled with the cooling air blown from the air passage 50. In addition, according to the configuration of (1), the cooling air is blown into the combustion chamber 160 from the air passage 50. In this manner, it is possible to prevent the flame from entering the acoustic attenuation space 45 through the plurality of through-holes.

According to the configuration of (1), at least one of the plurality of through-holes (acoustic holes 43) is provided directly below the air hole plate 25 in the axial direction. Therefore, combustion vibration can be effectively prevented.

That is, according to the configuration of the above (1), it is possible to achieve both cooling and acoustic characteristics in the gas turbine combustor 100.

(2) In some embodiments, in the configuration of (1), the combustion cylinder (combustor liner 153) may include a combustion cylinder body 31 that forms the combustion chamber 160, and a combustion cylinder fixing adapter 33 that is connected to an end portion 31u on an axial upstream side of the combustion cylinder body 31 by a welded portion 35. The welded portion 35 may be positioned on an upstream side with respect to an axial downstream end of the air passage 50.

According to the configuration of (2), the welded portion 35 which is relatively easily affected by heat can be effectively cooled by the cooling air flowing through the air passage 50.

(3) In some embodiments, in the configuration of (1) or (2), an annular cavity 53 that is formed between the inner peripheral surface 153b of the combustion cylinder (combustor liner 153) and the outer peripheral surface 25a of the air hole plate 25 and that extends in a circumferential direction of the combustion cylinder (combustor liner 153) may be provided. The air passage 50 may be connected to the annular cavity 53 at an upstream end of the air passage 50.

According to the configuration of (3), the annular cavity 53 is provided, so that it is possible to prevent the occurrence of the deviation of the flow speed of the cooling air for performing film-cooling on the combustion cylinder (combustor liner 153) from the air passage 50 in the circumferential direction of the combustion cylinder (combustor liner 153). Therefore, a temperature difference in the circumferential direction of the combustion cylinder (combustor liner 153) can be prevented.

(4) In some embodiments, in any one of the configurations of (1) to (3), the air passage 50 may be an annular air passage 50 that extends in a circumferential direction of the combustion cylinder (combustor liner 153) and includes a first region 51 and a second region 52 positioned on an axial downstream side with respect to the first region 51, and a height h2 of the combustion cylinder (combustor liner 153) in a radial direction in the second region 52 is greater than a height h1 in the radial direction in the first region 51.

According to the configuration of (4), since the height in the radial direction changes from the first region 51 to the second region 52, the flow of the cooling air flowing through the air passage 50 is disturbed when flowing from the first region 51 to the second region 52. Therefore, even when there is a deviation in the flow speed of the cooling air flowing through the first region 51 in the circumferential direction, the deviation in the circumferential direction can be prevented by disturbing the cooling air when the cooling air flows from the first region 51 into the second region 52. Accordingly, it is possible to prevent the occurrence of a deviation in the flow speed of the cooling air from the air passage 50 which is blown out to perform film-cooling on the combustion cylinder (combustor liner 153) in the circumferential direction.

(5) In some embodiments, in the configuration of the above (4), the combustion cylinder (combustor liner 153) may include a combustion cylinder body 31 that forms the combustion chamber 160, and a combustion cylinder fixing adapter 33 that is connected to an end portion 31u on an axial upstream side of the combustion cylinder body 31 by a welded portion 35. The welded portion 35 may be positioned within an extending range of the second region 52 in the axial direction.

According to the configuration of (5), the welded portion 35 can be cooled by the cooling air in which the deviation of the flow speed in the circumferential direction is prevented. Therefore, the deviation of the temperature of the welded portion 35 in the circumferential direction can be prevented.

(6) In some embodiments, in any one of the configurations of (1) to (5), the combustion cylinder (combustor liner 153) may be formed with a plurality of cooling passages 312 that extend along the axial direction inside walls 31W configuring the combustion cylinder (combustor liner 153) and that are separated from each other along a circumferential direction of the combustion cylinder (combustor liner 153). The plurality of cooling passages 312 may include an inlet opening 312a that is open to an outer peripheral surface 153a (outer peripheral surface 31a of combustion cylinder body 31) of the combustion cylinder (combustor liner 153) on an axial downstream side with respect to the housing 41 and an outlet opening 312b that is open to the outer peripheral surface 153a (outer peripheral surface 31a of combustion cylinder body 31) of the combustion cylinder (combustor liner 153) to face the acoustic attenuation space 45, and configure the air supply flow path 49.

According to the configuration of (6), the air (high-pressure air 120) flowing on the outer side of the combustion cylinder (combustor liner 153) can be circulated as the cooling air in the plurality of cooling passages 312. Therefore, the combustion cylinder (combustor liner 153) can be effectively cooled. In addition, the cooling air that has flowed through the plurality of cooling passages 312 can be supplied to the acoustic attenuation space 45. Therefore, the cooling air can be blown into the combustion chamber 160 from the plurality of through-holes (acoustic holes 43). Accordingly, the cooling air can be efficiently used, and the flame can be prevented from entering the acoustic attenuation space 45 through the plurality of through-holes (acoustic hole 43).

(7) In some embodiments, in any one of the configurations (1) to (6), the housing 41 may have a housing through-hole 47 that penetrates the housing 41 and that configures the air supply flow path 49.

According to the configuration of (7), the air (high-pressure air 120) flowing on the outer side of the combustion cylinder (combustor liner 153) can be introduced from the housing through-hole 47 into the acoustic attenuation space 45 and blown into the combustion chamber 160 from the plurality of through-holes (acoustic holes 43). Accordingly, a region prone to reach a relatively high temperature can be cooled by the cooling air blown from the plurality of through-holes (acoustic holes 43), and the flame can be prevented from entering the acoustic attenuation space 45 through the plurality of through-holes (acoustic holes 43).

(8) In some embodiments, in any one of the configurations of (1) to (7), the gas turbine combustor 100 may be a hydrogen-exclusive combustor.

According to the configuration of (8), it is possible to prevent emission of carbon dioxide from the gas turbine combustor 100.

(9) The gas turbine 1 according to at least one embodiment of the present disclosure includes a compressor (air compressor 110) that generates compressed air; the gas turbine combustor 100 according to any configuration of (1) to (8); and a turbine 180 that is rotationally driven by combustion gas 170 generated by the gas turbine combustor 100.

According to the configuration of (9), the gas turbine 1 including the gas turbine combustor 100 that achieves both cooling and acoustic characteristics can be realized.

### REFERENCE SIGNS LIST

1: gas turbine
25: air hole plate
25a: outer peripheral surface
31: combustion cylinder body
31a: outer peripheral surface
31u: end portion
31W: wall
33: combustion cylinder fixing adapter
33b: inner peripheral surface
35: welded portion
40: acoustic device
41: housing
43: acoustic hole
45: acoustic attenuation space
47: housing through-hole
49: air supply flow path
50: air passage
50u: upstream end
50d: downstream end
51: first region
52: second region
53: annular cavity
100: gas turbine combustor
110: air compressor (compressor)
120: high-pressure air
153: combustor liner (inner cylinder, combustion cylinder)
153b: inner peripheral surface
180: turbine
250: air hole
312: cooling passage
312a: inlet opening
312b: outlet opening

1. A gas turbine combustor comprising:
a combustion cylinder which includes a combustion chamber inside and in which a plurality of through-holes open to the combustion chamber are formed;
a housing that is disposed on an outer peripheral side of the combustion cylinder and that defines an acoustic attenuation space that communicates with the combustion chamber via the through-hole;
an air hole plate in which a plurality of air holes are formed and which is positioned on an upstream side of the combustion cylinder;
a plurality of fuel nozzles that correspond to the plurality of air holes, respectively;
an air passage that is provided between an inner peripheral surface of the combustion cylinder and an outer peripheral surface of the air hole plate and that extends in an axial direction of the combustion cylinder; and
an air supply flow path for supplying air flowing on an outer side of the combustion cylinder to the acoustic attenuation space,
wherein at least one of the plurality of through-holes is provided directly below the air hole plate in the axial direction.

2. The gas turbine combustor according to claim 1,
wherein the combustion cylinder includes a combustion cylinder body that forms the combustion chamber, and a combustion cylinder fixing adapter that is connected to an end portion on an axial upstream side of the combustion cylinder body by a welded portion, and
the welded portion is positioned on an upstream side with respect to an axial downstream end of the air passage.

3. The gas turbine combustor according to claim 1, further comprising:
an annular cavity that is formed between the inner peripheral surface of the combustion cylinder and the outer peripheral surface of the air hole plate and that extends in a circumferential direction of the combustion cylinder,
wherein the air passage is connected to the annular cavity at an upstream end of the air passage.

4. The gas turbine combustor according to claim 1,
wherein the air passage is an annular air passage that extends in a circumferential direction of the combustion cylinder and includes a first region and a second region positioned on an axial downstream side with respect to the first region, and
a height of the combustion cylinder in a radial direction in the second region is greater than a height of the combustion cylinder in the radial direction in the first region.

5. The gas turbine combustor according to claim 4,
wherein the combustion cylinder includes a combustion cylinder body that forms the combustion chamber, and a combustion cylinder fixing adapter that is connected to an end portion on an axial upstream side of the combustion cylinder body by a welded portion, and
the welded portion is positioned within an extending range of the second region in the axial direction.

6. The gas turbine combustor according to claim 1,
wherein the combustion cylinder is formed with a plurality of cooling passages that extend along the axial direction inside walls configuring the combustion cylinder and that are separated from each other along a circumferential direction of the combustion cylinder, and
the plurality of cooling passages include an inlet opening that is open to an outer peripheral surface of the combustion cylinder on an axial downstream side with respect to the housing and an outlet opening that is open to the outer peripheral surface of the combustion cylinder to face the acoustic attenuation space, and configure the air supply flow path.

7. The gas turbine combustor according to claim 1,
wherein the housing has a housing through-hole that penetrates the housing and that configures the air supply flow path.

8. The gas turbine combustor according to claim 1,
wherein the gas turbine combustor is a hydrogen-exclusive combustor.

9. A gas turbine comprising:
a compressor that generates compressed air;
the gas turbine combustor according to claim 1; and
a turbine that is rotationally driven by combustion gas generated by the gas turbine combustor.
